(19) United States
(12) Patent Application Publication
(10) Pub. No.: US 2013/0291448 A1
(43) Pub. Date: Nov. 7, 2013

(54) Interlocking eavestrough cover

(71) Applicant: Strphane Brochu, St-Romuald (CA)

(72) Inventor: Strphane Brochu, St-Romuald (CA)

(21) Appl. No.: 13/506,610

(22) Filed: May 2, 2012

(51) Int. Cl. E04D 13/076; B23P 17/04

(52) U.S. Cl. 52/12; 29/428

(57) ABSTRACT

An eavestrough cover comprising a plurality of pieces of a foraminous material lying in an end to end relationship to cover an eavestrough, a first end of a first piece of the foraminous material having a slot formed therein, a second end of a second piece of foraminous material being placed within the slot such that there are formed respective underlying/overlying portions of the first and second pieces of foraminous material.

### FIELD OF THE INVENTION

The present invention relates to an eavestrough cover and more particularly, relates to an easily installed eavestrough cover.

### BACKGROUND OF THE INVENTION

The use of eavestrough covers to prevent extraneous material from entering the eavestrough and possibly clogging the same is well known in the art. There have been many proposals for such eavestrough covers and many are directed to arrangements which frequently require the use of a skilled technician for installation. Usually, such eavestrough covers are formed as a single piece and accordingly, are of a substantial length. In order to form the same, specialized equipment is required.

For the do-it-yourselfer, eavestrough covers of a substantial length are not readily available and pose problems for transportation of the same.

### SUMMARY OF THE INVENTION

It is an object of the present invention to provide an eavestrough cover which may be easily installed by a do-it-yourselfer.

According to one aspect of the present invention, there is provided an eavestrough cover comprising a plurality of pieces of a foraminous material lying in an end to end relationship to cover an eavestrough, a first piece of foraminous material having first and second ends, the first end having a slot formed therein, a second piece of foraminous material having first and second ends, the first end having a slot formed therein, the second end of the second piece of foraminous material extending within the slot of the first piece of foraminous material such that a first portion of the second end of the second piece of foraminous material overlies a portion of the first piece of foraminous material and a second portion of the second end of the second piece of foraminous material underlies a portion of the first end of the first piece of foraminous material.

According to a further aspect of the present invention, there is also provided an elongated piece of foraminous material for use in an eavestrough cover, a first end of the foraminous material having a slot formed therein, first and second side structures extending from a second end of the foraminous material to a point where the slot terminates.

According to a still further aspect of the present invention, there is also provided a method of installing an eavestrough cover on an eavestrough comprising the steps of supplying first and second pieces of foraminous material, a first piece of foraminous material having first and second ends, the first end having a slot formed therein, a second piece of foraminous material having first and second ends, the first end having a slot formed therein, placing the first piece of foraminous material to cover a first section of the eavestrough, optionally securing the first foraminous member to the eavestrough, inserting the second end of the second piece of foraminous material in the slot of the first piece of foraminous material while maintaining the second piece of foraminous material at an angle with respect to the first piece of foraminous material, turning the second piece of foraminous material such that the second end of the second piece of foraminous material overlies a portion of the first piece of foraminous material and a second portion of the second end of the second piece of foraminous material underlies a portion of the first end of the first piece of foraminous material, and securing the second piece of foraminous material to the eavestrough.

The eavestrough cover of the present invention is formed by utilizing a plurality of elongated strips of a manageable length. Typically, such strips would range between 6 and 12 feet long so that they may be transported by the end user. However, it will be understood that any desired length may be utilized.

The eavestrough cover may be formed of any desired material with a metallic material such as aluminum being largely utilized. Plastic eavestrough covers could likewise be employed.

The eavestrough, as above mentioned, is formed of a plurality of lengths laid in an end to end relationship in order to cover the length of the eavestrough. In order to maintain the pieces in place, they are formed to have an interlocking structure. This is accomplished by the provision of slot at one end of each piece of foraminous material.

In order to install the eavestrough guard, a first piece is laid on top of the eavestrough and optionally secured thereto. The second piece is then inserted such that the non slotted end of the second piece is inserted into the slot in the first piece. The second piece is then allowed to rotate such that a first portion of the second piece overlies a portion of the first piece and a second portion of the second piece underlies a second portion of the first piece. Preferably, the length of the slot is such that apertures in each of the foraminous pieces align with each other through the overlying/underlying areas.

Depending on the nature of the installation, each individual piece may be secured to the eavestrough structure by any suitable manner. Many such proposals have been advanced in the art and could be utilized with the present invention.

Preferably, the foraminous pieces have a first side structure and a second side structure associated therewith. The side structures may be utilized to help attach the foraminous pieces to the eavestrough structure. In order to provide for smooth abutting relationship, each of the side structures will extend from the non slotted end to a point at which the slot terminates.

### BRIEF DESCRIPTION OF THE DRAWINGS

Having thus generally described the invention, reference will be made to the accompanying drawings illustrated an embodiment thereof, in which:

FIG. 1 is a perspective view of a portion of two pieces of an eavestrough cover before installation;

FIG. 2 is a top plan view thereof;

FIG. 3 is a perspective view illustrating assembly of the two pieces of the eavestrough cover; and

FIG. 4 is a top plan view of the assembled pieces.

### DETAILED DESCRIPTION OF THE INVENTION

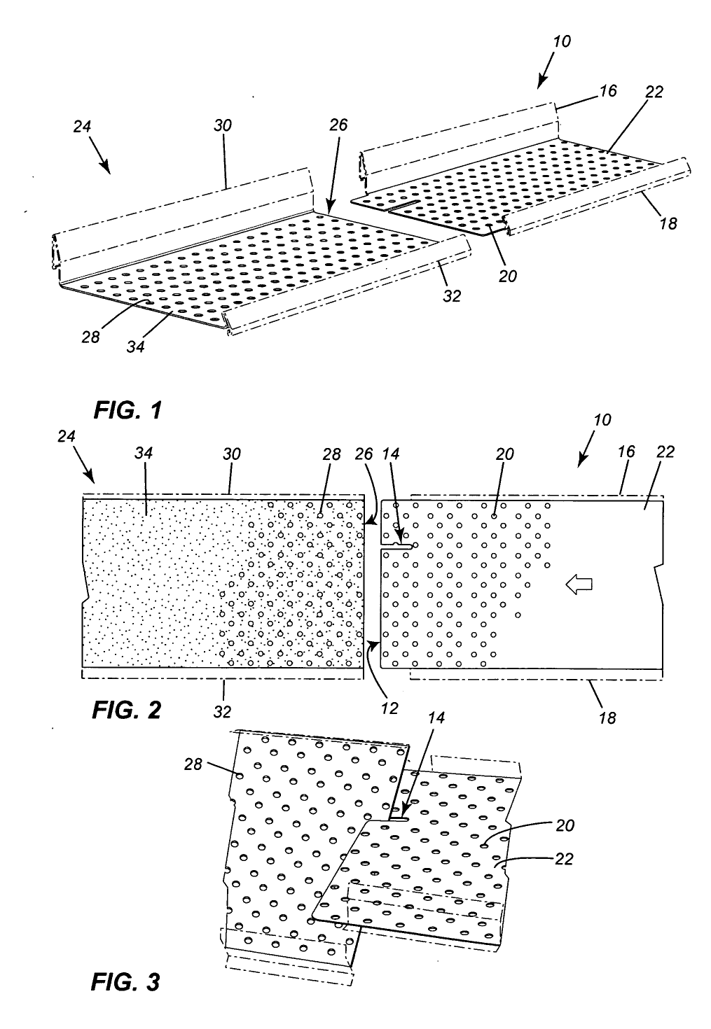

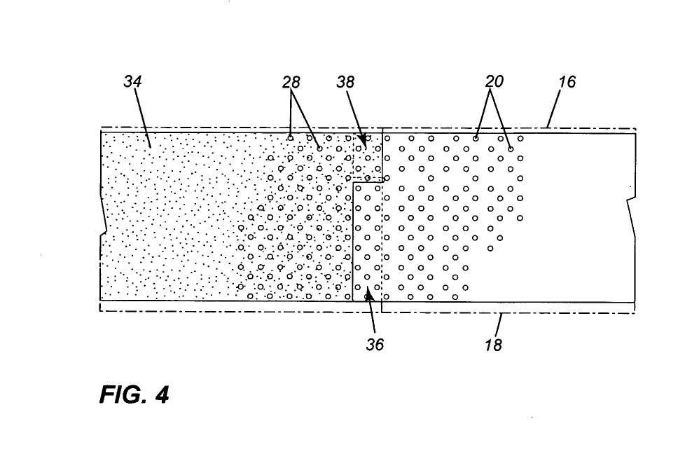

Referring to the drawings in greater detail and by reference characters thereto, there is illustrated in FIG. 1 a first piece of foraminous material generally designated by reference numeral 10 which forms a portion of the eavestrough cover. First piece of foraminous material 10 has a first end generally designated by reference numeral 12 and which has slot 14 formed therein.

First piece of foraminous material 10 has first side structure 16 extending alongside the central planar portion 22. A second side structure 18 is formed on the other side of central planar portion 22. Central planar portion 22 includes a plurality of drainage apertures 20 formed therein.

First side structure 16 and second side structure 18 extend along their respective sides of first piece of foraminous material 10 from a second end (not shown) thereof. It will be noted that they terminate short of the first end; they extend only to the inner most point of slot 14.

A second piece of foraminous material is generally designated by reference numeral 24 and only the second end portion 26 is illustrated. There is a first opposite end having a slot formed therein. As was the case with first piece of foraminous material 10, second piece of foraminous material 24 has a central planar portion 34 with apertures 28 formed therein. Being substantially identical to first piece of foraminous material 10, second piece of foraminous material 24 has a first side structure 30 extending along a first side of central planar portion 34 and a second side structure 32 extending along the opposite side of central planar portion 34.

When installing the gutter cover, first piece of foraminous material 10 may be placed on top of the eavestrough. Optionally, the first piece of foraminous 10 may be secured to the gutter in an appropriate fashion.

Subsequently, second piece of foraminous material 24 is angled slightly with respect to first piece of foraminous material 10 such that the second end 26 of the second piece of foraminous material 24 is inserted in slot 14. Subsequently, second piece of foraminous material 24 is allowed to rotate such that there is provided a first portion generally designated by reference numeral 36 wherein first end 12 of the first piece of foraminous 10 overlies the second end 26 of second piece of foraminous material 24. On the other side of slot 14, second end 26 of second piece of foraminous material 24 overlies a second portion 38 of first end 12 of first piece of foraminous material 10.

It will be noted that due to the length of first side structure 16 and second side structure 18, there is an abutment with first side structure 30 and second side structure 32 of the second piece of foraminous material 24 to form a tight abutting relationship.

The various pieces of foraminous material may be secured to the eavestrough as they are installed or they may be secured only when the eavestrough cover is complete.

It will be understood that the above described embodiment is for purposes of illustration only and that changes and modifications may be made thereto without departing from the spirit and scope of the invention.

I claim:

1. An eavestrough cover comprising a plurality of pieces of a foraminous material lying in an end to end relationship to cover an eavestrough;
a first piece of foraminous material having first and second ends, said first end having a slot formed therein;
a second piece of foraminous material having first and second ends, said first end having a slot formed therein, said second end of said second piece of foraminous material extending within said slot of said first piece of foraminous material such that a first portion of said second end of said second piece of foraminous material overlies a portion of said first piece of foraminous material and a second portion of said second end of said second piece of foraminous material underlies a portion of said first end of said first piece of foraminous material.

2. The eavestrough cover of claim 1 wherein said first and second pieces of foraminous material are formed of a metallic or plastic material.

3. The eavestrough cover of claim 1 wherein said pieces of foraminous material have a first side structure and a second side structure, both side structures extending longitudinally therealong, said first side structure and said second side structure terminating at the innermost point of said slot.

4. The eavestrough cover of claim 3 wherein said slot is sized such that apertures in said overlying and underlying portions of said second piece of foraminous material align with apertures in said first piece of foraminous material.

5. An elongated piece of foraminous material for use in an eavestrough cover, a first end of said foraminous material having a slot formed therein, first and second side structures extending from a second end of said foraminous material to a point where said slot terminates.

6. A method of installing an eavestrough cover on an eavestrough comprising the steps of:
supplying first and second pieces of foraminous material, said first piece of foraminous material having first and second ends, said first end having a slot formed therein, said second piece of foraminous material having first and second ends, said first end of said second piece of foraminous material having a slot formed therein;
placing said first piece of foraminous material to cover a first section of said eavestrough, optionally securing said first foraminous member to said eavestrough;
inserting said second end of said second piece of foraminous material in said slot of said first piece of foraminous material while maintaining said second piece of foraminous material at an angle with respect to said first piece of foraminous material;
turning said second piece of foraminous material such that said second end of said second piece of foraminous material overlies a portion of said first piece of foraminous material and a second portion of said second end of said second piece of foraminous material underlies a portion of said first end of said first piece of foraminous material; and
securing said second piece of foraminous material to said eavestrough.
